(19) United States
(12) Patent Application Publication
(10) Pub. No.: US 2002/0185382 A1
(43) Pub. Date: Dec. 12, 2002

(54) Method for electrochemical treatment of effluents, especially effluents from leather tanneries, comprising chromium salts

(76) Inventors: Jean-Francois Fauvarque, Paris (FR); Jean-Claude Catonne, La Celle-Saint-Cloud (FR); Gerard Lalleve, Le Mesnil-Saint-Denis (FR)

Correspondence Address: Stevens Davis Miller & Mosher, Suite 850, 1615 L Street NW, Washington, DC, 20036, US

(21) Appl. No.: 09/937,603

(22) PCT Filed: Mar. 31, 2000
(86) PCT No.: PCT/FR00/00821

(30) Foreign Application Priority Data
Apr. 1, 1999 (FR) 99/04,085

(51) Int. Cl. C02F 1/461

(52) U.S. Cl. 205/742; 205/687; 205/751; 205/704

(57) ABSTRACT

The present invention relates to a method for treating effluents, especially the effluents from leather tanneries, containing chrome salts, i.e. the salts of chromium having a (III) oxidation degree, characterized in that the supplied effluents or those having a pH that is lower than 6 undergo an electrochemical reaction in a reactor comprising an anode and a cathode in such a way that the chromium having a (III) oxidation degree is transformed into chrome having a (VI) oxidation degree, and in that the treated effluents are recovered. The treatment method is followed in an advantageous manner by a method for recovering the hexavalent chromium by means of selective extraction in an appropriate solvent medium followed by reduction of the hexavalent chromium into trivalent chromium.

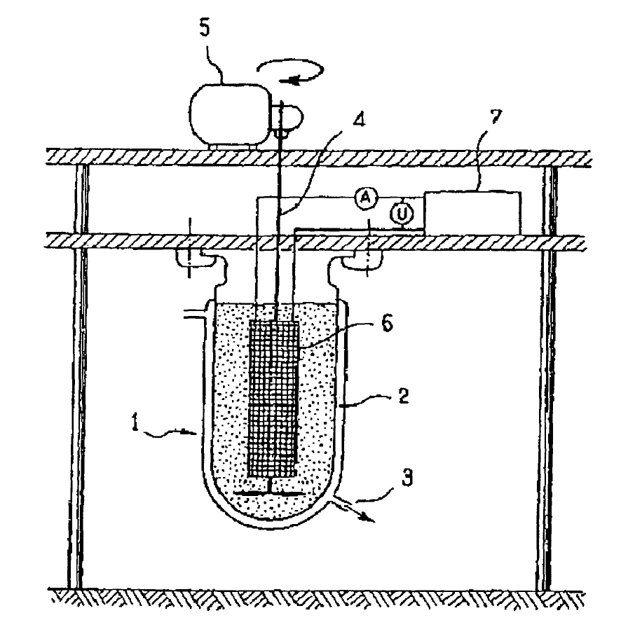

The present invention relates to a method for treating effluents, especially effluents from tanneries, comprising chromium salts, which allows good recovery of the chromium and destruction of the organic pollutants contained in said effluents.

The invention also relates to a treatment method using a subsequent step of recovery of the chromium for possible recycling in industry, especially for tanning leathers.

Trivalent chromium salts are used to tan animal hides and to convert them into leather. The trivalent chromium becomes inserted between the collagen fibers and crosslinks them, forming complexes with the anionic sites of the polypeptide chains.

Tanning with chromium salts gives a leather which has excellent physicochemical characteristics, especially suppleness, tear strength and great heat resistance (the hide is denatured only above 100° C.). Only a few special leathers are still manufactured with natural or synthetic organic tannins.

Tanning baths have quite a strong chromium concentration, typically 20 g/liter. During a tanning operation, the leather absorbs about 60% of this chromium. The effluents may thus contain up to 8 g/liter of chromium, usually about 2 g/liter. The spent bath may be recycled and refilled with chromium salt, either for a further tanning operation or during a pickling pretreatment. However, the quality of the leather is not as good if the bath contains a recycled effluent. The reason for this is that in the course of the recycling operations, the bath accumulates mineral salts and organic compounds, the content of which must be limited and controlled in order to obtain a leather of satisfactory quality. A purge is necessary, which constitutes essentially all the effluent, optionally with the rinsing waters. It is standard practice to recycle 50% of a spent bath. In modern units, recycling of 80% of the spent bath is possible. However, not all units have a recycling device. Precipitation of the chromium and its recovery constitute an alternative to the recycling of the spent bath, or a complement depending on the case. The chromium-containing effluents are treated with a base which precipitates the trivalent chromium, redissolved in dilute sulfuric acid and reused (Tanneries and the Environment, A technical guide to reducing the environmental impact of tannery operations. United Nations Publication 1991, United Nations Environment Programme (UNEP), Industry and Environment Office (IEO), 39 quai André Citroën, 75739 Paris Cedex 15).

The spent bath, the purge and the rinsing waters thus constitute the effluent from tanneries, which always contains a large amount of chromium, mineral salts and organic compounds such as fats and proteins. The table below gives a typical composition of a spent chromium tannery bath, excluding organic compounds. Its pH is in the region of 3.5.

| ions | Na⁺ | Cr³⁺ | Mg²⁺ | Ca²⁺ | HCOO⁻ | SO₄⁼ | Cl⁻ |
|---|---|---|---|---|---|---|---|
| conc. g/liter | 37 | 8 | 1.7 | 1 | 13 | 40 | 15 |

Table: Standard concentration of mineral ions in a tannery effluent.

Reference: T. F. O'Dwyer & B. K. Hodnett, J. Chem. Tech. Biotechnol., 1995, 62, 30-37.

Although this is not always carried out, it is useful to recover the chromium present, both for economic reasons and for reasons of environmental protection. The method most commonly used for removing the chromium from the effluents consists in precipitating it by increasing the pH to about 8-9. This increase is obtained by adding lime or magnesia. Chromium trihydroxide Cr(OH)₃, magnesium chromite MgCr₂O₄ or calcium chromite CaCr₂O₄, that are very sparingly soluble, and calcium sulfate, that is sparingly soluble, are formed.

The precipitate may be filtered off and washed and then treated with H₂SO₄ to reform a chromium sulfate solution. It is also possible to leave it simply to separate out by settling. For this operation, which is more economical, lime is best. However, the most advantageous precipitant is magnesia, since its use avoids the formation of a large amount of precipitated calcium sulfate. The precipitate, treated with dilute sulfuric acid, gives a chromium sulfate solution containing 20-90 g/liter which may be reused for the tanning. However, the chromium sulfate solution thus recovered always contains other ions present in the precipitate or in the interstitial liquid and organic impurities. It does not allow a tanning of as good a quality as that obtained with pure basic chromium sulfate. Moreover, it is preferable to treat the filtrate and the rinsing waters in order to destroy the often malodorous organic compounds present, before discharging it into a river or into settling basins.

Various processes have been proposed for more selectively recovering the chromium present in the filtered solid. One of the solutions consists in adsorbing the chromium III onto cation-exchange resins and eluting it by oxidizing it to soluble chromic acid using aqueous hydrogen peroxide solution (G. A. Sleater & D. H. Freeman, Analytical Chemistry 1970, 42, 1666). This method requires large excesses of H₂O₂ and is not industrializable. The principle of the method was taken up again and applied to tannery effluents by T. F. O'Dwyer and B. K. Hodnett (already cited). In this process, the Cr(III) of the effluent is first adsorbed onto a cation-exchange resin and then oxidized to Cr(VI) with ammonium persulfate at 100° C. or with sodium hypochlorite (bleach) at ambient temperature. This process has the advantage of destroying certain interfering ions such as formate ions. The Cr(VI) can be converted to Cr(III) by reduction, and the authors propose methanol as reducing agent but do not indicate how to isolate the pure chromium sulfate. However, the process requires a large excess of oxidizing agent, takes a long time and quite probably consumes a large amount of cation-exchange resin, especially if the resin is degraded during the oxidation. Now, it is known that acidic Cr(III) solutions may be converted into Cr(VI) solutions by electrochemical oxidation. However, the processes currently described all use ion-exchange membranes to separate the anode compartment, in which the oxidation of the chromium takes place, from the cathode compartment, in which the Cr(VI) might be reduced (J. L. Pillaud, C. Roulph & M. Rumeau, Galvano-organo—Traitements de surface [Surface treatments], No. 585, April 1988, p. 333).

However, an ion-exchange membrane should be made of perfluorinated material, which is expensive, to withstand the oxidation. Cation-exchange membranes of the “Nafion” type risk being rapidly “blocked” by the Cr³⁺ ions. Anion-exchange membranes are less selective and probably also less durable. However, under concentration conditions corresponding to the treatment of tannery effluents (treatment of the precipitates or the raw effluents), it has been found that it is possible to oxidize chromium III into chromium VI at the anode, and to reduce water (or protons) to hydrogen at the cathode, without using a membrane or other separator, and without any appreciable reduction of the chromium VI to chromium III at the cathode. The object of the present invention is to propose a novel method for the electrochemical treatment of tannery effluents in order to quantitatively oxidize trivalent chromium to hexavalent chromium and simultaneously to destroy the oxidizable organic compounds. The method proposed applies both to the raw effluent and to the precipitate obtained using lime or magnesia, provided that the pH of the medium has been adjusted to a value that is not too basic at the start (pH<5) if necessary. Once the electrochemical treatment has been performed, the hexavalent chromium is recovered by means of a suitable method. A solution remains which now contains only mineral ions that are compatible with industrial discharges. The hexavalent chromium obtained may be used as is in chromating baths or may be converted into a trivalent chromium derivative which may be used in a tannery. The invention thus relates, firstly, to a method for treating effluents, especially effluents from tanneries, comprising chromium of oxidation state III, characterized in that said effluents, brought to or being at a pH below 6, are subjected, in a compartment comprising an anode and a cathode, to an electrochemical reaction such that the chromium of oxidation state III is converted into chromium of oxidation state VI and in that said treated effluents are recovered.

Preferably, a cathode with a low surface area relative to the anode is used, in a relatively acidic medium (pH<4) such that the reduction of water takes place preferentially to the reduction of the chromium VI. The effect observed may be explained by the fact that the electric field in the region of the cathode repels the chromate ions CrO₄²⁻. These ions can reach the cathode only by diffusion, this phenomenon being limited by the low total chromium concentration. It is also known that the reduction of chromium VI to chromium III is difficult, whereas the reduction of water or that of solvated protons is easy on materials with a low hydrogen overvoltage, for instance platinum.

According to a first aspect of the present invention, the electrochemical reactor which is capable of converting the trivalent chromium derivatives into hexavalent chromium is not equipped with ion-exchange membranes or other separators. It is thus a single compartment.

According to one preferred variant, the electrochemical reaction is carried out at a temperature of between about 50° C. and 100° C. and advantageously between about 80° C. and 95° C.

The reaction medium preferably has a pH of less than 4 and greater than 2.

According to another preferred variant, the ratio between the active surface of the cathode and the active surface of the anode is between 1/100 and 20/100. The anode may be in the form of an expanded cylinder, for example of platinized titanium, and the cathode may be in the form of an expanded cylinder, for example of titanium. These anodes and cathodes have suitable mesh sizes which may be determined by a person skilled in the art. For example, the anode may be of mesh size F and the cathode of mesh size N.

In the case of tannery effluents, the chromium concentration usually ranges between 1 g and 8 g of chromium per liter. However, the invention is not limited to this variant and other chromium concentrations may be envisaged depending on the nature and origin of the effluents.

The current applied depends partly on the duration of the electrolysis. A person skilled in the art may adapt these parameters depending on the nature of the effluent. Nevertheless, it will be noted that an electrolysis of short duration with low currents makes it possible to obtain a better faradic yield, but at the expense of the chemical yield. In an industrial application, the parameters of this method should be adapted according to the amount of residual chromium present in the effluent. The current intensity is generally between 2 and 10 A per liter and the electrochemical reaction time is a few hours.

According to another variant of the method, said method comprises a prior step in which the effluents are subjected to a step of precipitation of the chromium of oxidation state III, recovery of the precipitate which is redissolved in acidic medium before the subsequent electrolysis.

As has been mentioned in the description of the prior art, the method most commonly used to carry out this precipitation consists in increasing the pH within the region of about 8-9. This increase is obtained by adding lime or magnesia, to form chromium trioxide Cr(OH)₃, magnesium chromite MgCr₂O₄ or calcium chromite CaCr₂O₄, that are very sparingly soluble, and calcium sulfate, that is sparingly soluble. The precipitate may be filtered off and washed, and then treated with H₂SO₄ to reform a chromium sulfate solution. It is also possible to leave it simply to separate out by settling. It is preferred to use lime CaO or magnesia MgO for this precipitation. However, according to one preferred variant, magnesia is used, which avoids the formation of a large amount of precipitated calcium sulfate. The precipitate, treated with dilute sulfuric acid, gives a chromium sulfate solution which is then subjected to the method according to the invention as described above.

The chemical oxidation yields of the chromium III to chromium VI are very high, of the order of 90% and even higher than 95%.

The invention has thus demonstrated that it is possible to efficiently convert solutions of chromium salts present in effluents.

However, the invention is not limited to this aspect as has just been described. Specifically, a subject of the invention is also a treatment method which comprises a subsequent step of recovering the trivalent chromium from the hexavalent chromium formed after the electrochemical reaction.

The invention thus relates to a process for treating effluents by means of an electrochemical reaction as described above, followed by a step of recovering the hexavalent chromium.

According to one variant, the precipitation takes place in the form of insoluble chromates; only barium chromate and lead chromate are very insoluble. It is possible to quantitatively remove the Cr(VI) by precipitation of PbCrO₄ using Pb(NO₃)₂, such a procedure runs the risk of leaving lead in the solution, which is not an environmentally satisfactory route.

Another variant which is preferred in the context of the present invention consists in carrying out a selective extraction of the chromic acid obtained (H₂CrO₄) with suitable organic solvents in acidic medium. The pH is less than or equal to 3, for example in the region of 1.

According to one practical embodiment, the electrolysis solution is acidified to the appropriate pH with sulfuric acid and is placed in contact with an organic solvent which allows a virtually total extraction of the chromic acid into the organic phase.

Among the organic solvents that are suitable, mention is made of solvents that are basic in the Lewis sense and that are sparingly soluble in water, for example trioctylamine, tributyl phosphate, tetrabutylammonium hydroxide optionally with a cosolvent of the volatile hydrocarbon type.

Among these cosolvents, petroleum hydrocarbons are preferred.

According to another advantageous variant of the method according to the invention, this method also comprises a step of recovering the trivalent chromium from the hexavalent chromium formed after the electrolysis reaction.

The organic solution can first be placed in contact with an acidic solution (for example dilute sulfuric acid), in the presence of a reducing agent, so as to reduce the hexavalent chromium to trivalent chromium which passes into aqueous solution in the form of a chromium salt, for example chromium sulfate. Among the reducing agents that are suitable in the context of the present invention, mention is made of organic reducing agents such as formic acid and methanol, or mineral reducing agents such as sulfur dioxide or sodium bisulfite in aqueous medium, to form chromium sulfate Cr₂(SO₄)₃ directly in solution, or a basic chromium sulfate, for possible recycling. It is advantageous to use a reducing agent whose oxidation product is gaseous, such as carbon dioxide, or compatible, such as SO₄²⁻ anions.

The reactions may be represented schematically according to the following equations:

3HCO²⁻+2CrO₄²⁻+5H⁺2Cr³⁺3CO₂+8H₂O or 3SO₂+2CrO₄²⁻+4H⁺→3SO₄²⁻+2Cr³⁺2H₂O

The last reaction has the obvious advantage of giving pure chromium III sulfate directly. The sulfur dioxide is an industrial product.

It is also possible to envisage an electrochemical reduction such as:

CrO₄²⁻+8H⁺+3e⁻→Cr³⁺+4H₂O.

Sodium chloride may also be added to the aqueous chromic acid solution, which makes the extraction of the chromium (VI) quantitative in a single operation, but it may be an inconvenience to have to discharge an effluent loaded with salt. According to another possibility, sodium sulfate is added if the solution used does not contain it in sufficient amount.

When the resulting solution comprises chromium sulfate, it may be directly recycled into the leather tanning process, for example.

By way of illustration, the single figure attached to the present description describes a diagrammatic view of an electrochemical reactor for performing the treatment method according to the invention.

This reactor, especially of “Grignard” type, is already described in “L'actualité chimique” of October 1998, No. 10, special edition, Organic Electrochemistry (part II), the authors of which are Muriel Mestre, Jean-Francois Fauvarque and Hatem Marzouk, pages 38-47.

According to this figure, the reactor 1, having a jacket 2 inside which flows a coolant fluid 3, is equipped with a stirrer 4 actuated by a motor 5. The anode 6 is an expanded metal cylinder arranged coaxially around the stirrer, and the cathode (not shown) is placed coaxially around the stirrer such that the cathode surface is of low surface area relative to that of the anode. The anode is connected to a generator 7.

The invention has been described in general terms, and is now illustrated by means of production examples given as a guide.

### EXAMPLE 1

The electrochemical reactor is represented diagrammatically in the figure, and consists of a jacketed, thermostatically regulated reactor of commercial “Grignard” type, equipped with a Teflon impeller stirrer.

The volume treated is 1 liter and initially contains a chromium (III) sulfate Cr₂(So₄)₃ solution at a concentration of from 2 g to 8 g of chromium per liter. The pH is adjusted to 3 by addition of sulfuric acid.

The anode is a “Degussa” platinized titanium expanded cylinder of mesh size F, with a radius of 47.7 mm, a height of 100 mm and apparent surface area of 6.6 dm², the cathode placed at the center, surrounding the stirrer shaft, is a “Degussa” expanded titanium cylinder of mesh size N, with a radius of 6 mm, a height of 80 mm and an apparent surface area of 0.41 dm².

A series of experiments was carried out at variable current density and variable temperature and showed that good electrolysis conditions in the region of:

temperature from 80° C. to 95° C.,

current 2 to 10 A,

initial concentration from 2 to 8 g/l.

Under these conditions, an electrolysis for 4 hours, passing an amount of current of 4 faradays per Cr³⁺ (i.e. a 33% excess) makes it possible to obtain a chemical yield of greater than 95% of soluble chromic acid (the pH becomes about 1). The voltage across the terminals never exceeds 6 V.

It was thus demonstrated that it is possible efficiently to convert chromium sulfate solutions into a mixture of sulfuric acid and chromic acid.

The method was then applied to a chromium leather tanning effluent according to the procedure described in Example 2.

### EXAMPLE 2

The initial solution is used as supplied, and is cloudy and green-blue. The amount of chromium present is 1.954 g/l. It contains chloride, sulfate and formate ions in unspecified amount but in the region of:

Cl⁻: 1 M

SO₄²⁻: 0.5 M

HCO²⁻: 0.25 M

(initial pH of 3.23)

and other unidentified organic compounds. The solution is placed in the above reactor, maintained at 80° C. and electrolyzed for 270 minutes under 5.5 A, the voltage across the terminals remaining between 4.7 and 5.4 volts. At the start of the electrolysis, a foam forms, which disappears thereafter. This foam probably arises from the presence of fatty acids in the medium, originating from the grease in the hides. These surfactant products appear to be oxidized during the electrolysis. The presence of chlorides and of the acid medium induces the formation of chlorine which is entrained by a stream of air and absorbed in the sodium hydroxide. At the end of electrolysis, the solution then contains only:

5×10⁴ g of Cr(III) in solution, and

1.737 g of Cr(VI) (CrO₄²⁻) in solution.

The rest of the chromium is contained in a deposit adhering to the cathode (0.94 g of deposit) containing about 20% chromium, this deposit (very probably magnesium chromite or calcium chromite) dissolves in the sulfuric acid and the solution obtained may be added to the following electrolysis. The solution at the end of electrolysis is pale yellow, entirely transparent and has a pH of 4.14 (this pH is slightly high and might advantageously be reduced by addition of a small amount of H₂SO₄)

The chemical yield for the oxidation of the chromium III into chromium VI reaches 89% in this example (without taking into account the chromium III that may be recovered in the deposit), although the faradic yield is low (11%). This is due to the simultaneous oxidation of the organic materials present (formates, oxylates, greases and soluble proteins) and of the chloride ions.

### EXAMPLE 3

One liter of tannery effluent, containing 1.97 g of chromium, is electrolyzed in the same apparatus for 320 minutes under 7 amperes at 95° C. The voltage remains between 5.7 and 5.9 volts and the same quantitative phenomena are observed: formation of foam at the start of the electrolysis, followed by its disappearance, production of chlorine, passage from a turbid greenblue solution to a transparent pale yellow solution, formation of a deposit at the cathode (1.06 g).

At the end, there remains in the solution:

less than 10-3 g of Cr(III) in solution

1.67 g of Cr(VI) (85%) has been formed (the rest of the chromium is present in the deposit).

The final pH is 5.3 and the faradic yield is 7%. In solution, the Cr(VI)/Cr(III) ratio is greater than 1000.

A shorter electrolysis (240 minutes) at lower current (3 A) gives a better faradic yield (17%) but at the expense of the chemical yield (65%). Cr(III) then remains in solution (0.632 g out of the initial 2 g). In an industrial application, the method should be optimized according to the techniques that are well known, as a function of the amount of residual chromium that is tolerable in the effluent.

The above examples relate to treatments of raw effluents; it is obvious that it is possible beforehand to precipitate the Cr(III) contained in the effluent by means of magnesia MgO, and then to redissolve the precipitate in dilute sulfuric acid and to electrolyze the solution obtained to convert the Cr(III) into Cr(VI) as described in Example 4.

### EXAMPLE 4

4 g of magnesia are added to one liter of tanning bath discharge; a precipitate of MgCr₂O₄ forms and the pH of the solution rises to 9.5. The precipitate is separated out by filtration and redissolved with H₂SO₄, and the volume of the solution is adjusted to one liter. The solution obtained contains 2.07 g of chromium and has a pH of 2.75. This solution is electrolyzed for 260 minutes under 6 amperes at 90° C. During the electrolysis, the voltage ranges between 7.6 and 8.4 volts. At the end of the electrolysis, the solution contains 0.215 g of Cr(III) and 1.835 g (90%) of Cr(VI) and its pH is 1.5.

Naturally, it is possible to perform similar electrolyses on more concentrated solutions. This example shows that the method is effective even on dilute solutions. It is also possible to add sodium sulfate to the solution to reduce the electrolysis voltage. In a more industrial method such conditions would naturally be achieved.

Example 5 below demonstrates the feasibility of the extraction of chromic acid, followed by its reduction.

### EXAMPLE 5

An aqueous chromic acid solution containing 4.33 g of chromium per liter (50 ml) is acidified with 1 ml of concentrated sulfuric acid. The solution is extracted twice with 30 ml of tributyl phosphate, and the organic solution turns yellow.

The residual chromium (VI) in the aqueous phase is assayed by potentiometry using a ferrous salt solution. 0.086 g of chromium per liter is found. The extraction has thus extracted more than 98% of the chromium (VI) present in the solution.

(Comment: the addition of sodium chloride to the aqueous phase makes the extraction of the chromium (VI) quantitative in a single operation, but it may be an inconvenience to have to discard an effluent filled with salt. Another possibility consists in adding sodium sulfate if the solution used does not contain it in sufficient amount.)

The organic solution thus obtained (a little over 60 ml) is treated with 100 ml of 0.1 M NaHSO₃ solution, and the organic solution decolorizes. The aqueous phase turns green, which is a sign of the presence of chromium (III). Assay of the chromium in the aqueous phase gives 0.205 g of chromium, i.e. 94% of the chromium contained in the initial aqueous solution.

### EXAMPLE 6

A solution containing 4 g per liter of Cr (VI) is acidified with sulfuric acid. 100 g per liter of sodium chloride are added thereto. 30 ml of this solution are extracted with a mixture of 15 ml of tributyl phosphate and 15 ml of petroleum ether (40-70° C.). There is no longer any assayable chromium in the aqueous solution. In a first operation, the 30 ml of the organic phase are treated with 3 ml of 7 M sodium hydroxide. The chromium passes entirely into the aqueous solution in the form of sodium chromate.

The organic phase is reused for a new extraction of 30 ml of the initial aqueous phase, then treated with a stoichiometric amount of NaHSO₃ (80 mg) dissolved in 6 ml of sulfuric acid solution of pH 1. The chromium passes entirely into the aqueous solution in the form of chromium (III) sulfate at a concentration in the region of 20 g per liter, as is used in tanneries.

1. A method for treating effluents, especially effluents from tanneries, comprising chromium salts in particular chromium of oxidation state III, characterized in that said effluents, brought to or being at a pH below 6, are subjected, in a reactor comprising an anode and a cathode, to an electrochemical reaction such that the chromium of oxidation state III is converted into chromium of oxidation state VI and in that said treated effluents are recovered.

2. The method for treating effluents as claimed in claim 1, characterized in that the active surface area of the cathode is less than the active surface area of the anode, such that the reduction of water takes place preferentially to the reduction of the chromium (VI).

3. The method for treating effluents as claimed in either of claims 1 and 2, characterized in that said reactor is the type with only one compartment, not comprising a membrane or other separator inserted between the anode and the cathode.

4. The method for treating effluents as claimed in one of the preceding claims, characterized in that the electrochemical oxidation reaction is carried out at a temperature of between 50° C. and 100° C. and preferably between 80° C. and 95° C.

5. The method for treating effluents as claimed in one of the preceding claims, characterized in that, prior to the step of electrochemical oxidation reaction, the effluents are subjected to a step of precipitation of the chromium of oxidation state III and recovery of the precipitate which is redissolved in acidic medium for subsequent electrolysis.

6. The method for treating effluents as claimed in claim 5, characterized in that the precipitation is carried out using CaO or MgO.

7. The method for treating effluents as claimed in one of claims 1 to 6, characterized in that the chromium of oxidation state VI is recovered by precipitation or extraction.

8. The method for treating effluents as claimed in claim 7, characterized in that the chromium of oxidation state VI is recovered by selective extraction in a suitable solvent medium at a pH of less than or equal to 3.

9. The method for treating effluents as claimed in claim 8, characterized in that the organic solvent is chosen from trioctylamine, tributyl phosphate and tetrabutylammonium hydroxide, optionally in the presence of a volatile hydrocarbon.

10. The method for treating effluents as claimed in one of claims 1 to 6, characterized in that the chromium VI is reduced to chromium III in acidic solution in the presence of a reducing agent.

11. The method for treating effluents as claimed in claim 10, characterized in that the reducing agent is chosen from organic reducing agents such as formic acid or methanol, and mineral reducing agents such as sulfur dioxide or sodium bisulfite.

12. The method for treating effluents as claimed in claim 11, characterized in that the reducing agent is sulfur dioxide or sodium bisulfite in aqueous medium, to form chromium sulfate Cr₂(SO₄)₃ directly in solution, or a basic chromium sulfate, for possible recycling.
